(19) United States
(12) Patent Application Publication
(10) Pub. No.: US 2023/0114340 A1
(43) Pub. Date: Apr. 13, 2023

(54) IMAGING APPARATUS, IMAGE PROCESSING SYSTEM, VEHICLE, CONTROL METHOD OF IMAGE PROCESSING SYSTEM, AND RECORDING MEDIUM

(71) Applicant: CANON KABUSHIKI KAISHA, Tokyo (JP)

(72) Inventor: Rentaro Imai, Kanagawa (JP)

(21) Appl. No.: 17/960,875

(22) Filed: Oct. 6, 2022

(30) Foreign Application Priority Data
Oct. 12, 2021 (JP) 2021-167224

(51) Int. Cl. H04N 7/18; H04N 5/225; H04N 5/232; B60R 1/26; B60R 1/12

(52) U.S. Cl. CPC H04N 7/183; H04N 5/22525; H04N 5/23296; B60R 1/26; B60R 1/12; B60R 2001/1253; B60R 2300/8066

(57) ABSTRACT

A camera that picks up an image behind a vehicle in order to display an image behind the vehicle on an electronic rear-view mirror and a monitor installed on the vehicle is provided with an optical system configured to have a high resolution region that has a high image-forming magnification and a peripheral region that is formed around the high resolution region and has a lower image-forming magnification than the high resolution region and to form an optical image on an image sensor; and an image pickup means configured to output an image based on an optical image formed on the image sensor, wherein the camera is arranged on the vehicle such that a ground surface that is behind and near the vehicle and the position 80 cm high from the ground surface is included within a second field range in which an image is formed on the image sensor via the second region of the optical system.

### BACKGROUND OF THE INVENTION

### Field of the Invention

The present invention relates to an imaging apparatus that captures images behind a vehicle, an image processing system, a vehicle, and a control method of the image processing system, and a program.

### Description of the Related Art

Cameras mounted on a vehicle for capturing images behind the vehicle has two main uses. One is the use for an electronic rear-view mirror for capturing images to be displayed on an electronic rear-view mirror (hereinafter, referred to as “electronic rear-view minor”) provided for confirming the rear view of a vehicle during normal driving. In the application for the electronic rear-view mirror, cameras need a resolution and a dynamic range in which a region visible by a conventional rear-view mirror can be confirmed with visibility equal to or greater than compared to a conventional rear-view mirror. The other is the use for rear monitoring in which the rear-view of the vehicle is captured at a wide angle of view so that the rear-view of the vehicle is confirmed when the vehicle moves backward. When a driver operates a vehicle to move it backward, a wide angle of view is required so that the driver can recognize objects such as a vehicle, a non-vehicle, and another vehicle that may enter a moving route planned by the vehicle. Therefore, in the use for rear monitoring, a wide photographable vertical angle of view is required to widely view a region including the object and other vehicles that are approaching from the backward direction and an area that is the nearest, behind and directly below the vehicle, in addition to a region that is behind and near the vehicle. For example, Japanese Patent Application Laid-Open No. 2007-223342 discloses a system in which a plurality of cameras for capturing the image behind of a vehicle are arranged in a recess portion of a vehicle body to which a license plate at the rear of the vehicle is attached.

However, in the prior art disclosed in Japanese Patent Application Laid-Open No. 2007-223342, because a plurality of cameras are used by being switched, the viewpoint moves every time the cameras are switched, and thus the cameras cannot be used suitably. In addition, because the camera is arranged in the recess portion of the vehicle body, the camera may be blocked by the vehicle itself and may not be able to capture images behind and directly below the vehicle, so that the driver may worry about not being able to confirm the view behind and directly below the vehicle.

### SUMMARY OF THE INVENTION

The present invention provides an imaging apparatus capable of providing an image behind a vehicle that can be used for both an electronic rearview mirror and a monitor.

An imaging apparatus of the present invention is an imaging apparatus that picks up an image behind a vehicle in order to display an image behind the vehicle on an electronic rear-view mirror and a monitor installed on the vehicle comprising: an optical system configured to have a first region that has a high image-forming magnification and a second region that is formed around the first region and has a lower image-forming magnification than the first region and to form an optical image on an imaging sensor; and an image pickup means configured to output an image based on an optical image formed on the imaging sensor, wherein the imaging apparatus is arranged on the vehicle such that a ground surface near the rear side of the vehicle and the position 80 cm high from the ground surface is included within a second field range in which an image is formed on the imaging sensor via the second region of the optical system.

Further features of the present invention will become apparent from the following description of exemplary embodiments with reference to the attached drawings.

### BRIEF DESCRIPTION OF THE DRAWINGS

FIG. 1 is a schematic view showing a vehicle and an imaging apparatus provided on the vehicle viewed from the side surface.

FIG. 2 is a schematic view showing the inside of the vehicle viewed from a driver.

FIG. 3 shows a camera system of the vehicle.

FIG. 4 is a schematic view showing the structure of a camera.

FIG. 5 is a drawing that explains an example of the positional relation between an image sensor and an object image formed by an optical system.

FIG. 6 is a drawing that explains an example of the positional relation between a high resolution region and a peripheral region on a light receiving surface.

FIG. 7 is a drawing that explains an example of the positional relation between the high resolution region and the peripheral region on the light receiving surface.

FIG. 8 is a drawing that explains the relation between the field range of the imaging apparatus and the object behind the vehicle.

FIG. 9 is a schematic view showing the case in which the imaging apparatus is arranged at a position of the limit where the whole body of the infant is within a field range.

FIG. 10 is a drawing that explains the relation between the field range of the imaging apparatus arranged on the vehicle having a trunk room protruding rearward and the object behind the vehicle.

FIG. 11 is a drawing for explaining the relation between the field range of the imaging apparatus provided on the vehicle having a trunk room protruding behind and a vehicle behind the vehicle.

### DESCRIPTION OF THE EMBODIMENTS

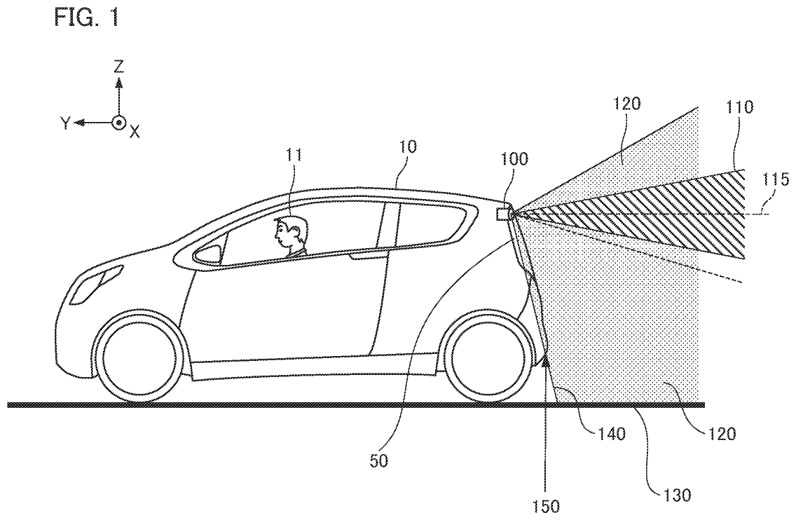

FIG. 1 is a schematic view showing a vehicle and an imaging apparatus provided on the vehicle viewed from the side surface. A vehicle 10 is a vehicle, for example, a passenger car and a bus on which a driver 11 can board and move to an arbitrary place. In FIG. 1, the left direction (Y-axis positive direction) is the front of the vehicle 10, and the right direction (Y-axis negative direction) is behind the vehicle 10. Additionally, in FIG. 1, the upward direction (Z-axis positive direction) is above the vehicle 10, and the downward direction (Z-axis negative direction) is below the vehicle 10. In FIG. 1, it is assumed that the vehicle 10 is arranged on a plane 130 parallel to the XY plane.

The vehicle 10 is provided with a camera 100 that captures images behind the vehicle 10 so that the driver 11 can confirm a video image behind the vehicle 10 with an electronic rear-view mirror 210 and a monitor 220 that is installed in front of a driver's seat. The camera 100 is an imaging apparatus that captures an image behind the vehicle 10 and acquire an image. One camera 100 is provided at the rear of the vehicle 10 in a direction in which the image of behind the vehicle 10 can be picked up. The camera 100 has an optical system 410 that forms a high-resolution region (first region) having a high optical imaging magnification and a peripheral region (second region) having a lower optical imaging magnification and resolution compared to the high-resolution region. Due to the optical system having different field ranges, the camera 100 can obtain a partial image having a narrow field angle but a high resolution by cutting out an image in a high-resolution area even when a wide-angle image including a peripheral area is captured. The field range (angle of view) imaged by the camera 100 includes a first field range 110 corresponding to a high-resolution region and a second field range 120 corresponding to a region around the first field range 110. The first field range 110 is formed on an image sensor 420 via the high-resolution region (first region) of the optical system 410 of the camera 100. The second field range 120 is formed on the image sensor 420 via the peripheral region (second region) of the optical system 410 of the camera 100. The camera 100 has a wide view angle, about 180 degrees.

The first field range 110 is a region in which light is incident to an image sensor, which is a photoelectric conversion element of the camera 100, via a high resolution region of the optical system of the camera 100. The second field range 120 is a region in which light is incident to the image sensor of the camera 100 via the peripheral region of the optical system of the camera 100. The first field range 110 includes an optical axis 115 of the camera 100. In addition, the camera 100 is arranged on the vehicle 10 such that the first field range 110 from a position where the camera 100 of the vehicle 10 so as to include a straight line that extends horizontally and rearward of the vehicle 10. The camera 100 is arranged such that the rear end of the camera 100 is placed more forward than a rear end portion 150 of the vehicle 10. In the present embodiment, although an example will be disclosed in which the camera 100 is arranged at the center in the X-direction of the rear portion of the vehicle 10 and near the upper end of a rear window portion 50 in the positive Z-axis direction in order to secure a wide field of view of the camera 100 toward a far distance behind the vehicle 10, the present invention is not limited thereto. The second field range 120 is provided so as to surround the periphery of the first field range 110. Additionally, the second field range 120 of the camera 100 is arranged so as to include at least the lower rear end (rear end portion 150) of the vehicle 10.

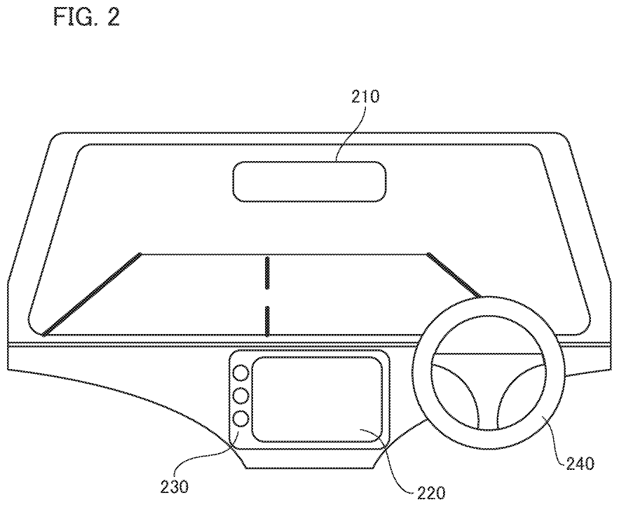

FIG. 2 is a schematic view showing the inside of the vehicle 10 as seen from the driver 11. The electronic rear-view mirror 210, the monitor 220, operation units 230, a steering wheel 240, and the like are installed inside the vehicle 10. The electronic rear-view mirror 210 is a display device that displays an image including at least a part of the first field range 110 corresponding to a high-resolution region from among the images captured by the camera 100. The display of the electronic rear-view mirror 210 is used to confirm and monitor the rear view during normal forward travel. Therefore, it is necessary to display a vehicle situated far behind that is moving at a high speed with a large size with high resolution. The electronic rear-view mirror 210 can switch between a rear-view mirror mode that displays an optical mirror image and an electronic rear-view mirror mode that displays an image captured by the camera 100.

The monitor 220 is a display device that can display an image captured by the camera 100. When the vehicle 10 moves backward (during rearward movement), the monitor 220 displays an image for the driver 11 to confirm the backward direction where the vehicle 10 is to be moved. The image displayed on the monitor 220 corresponds to an image having a capturing range wider than the partial image displayed on the electronic rear-view mirror 210. Additionally, the monitor 220 can also display a map image output from a car navigation system, a GUI for controlling the function of the audio device of the vehicle 10, and the like. The camera 100, which is a single camera, can pick up images displayed on the electronic rear-view mirror 210 and images displayed on the monitor 220.

The operation units 230 are operation members for receiving user operations such as a dial and a button. It is possible to display the GUI of the monitor 220 and control flu lions such as an air conditioner via the operation units 230. The steering wheel 240 is an operating member for controlling the moving direction (navigation angle) of the vehicle 10. The driver 11 controls the moving direction of the vehicle 10 by operating the steering wheel 240.

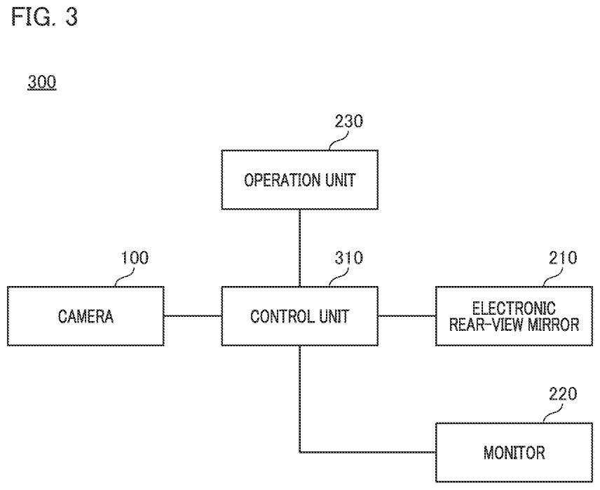

FIG. 3 illustrates an image processing system 300 of the vehicle 10. The image processing system 300 has the camera 100, the electronic rear-view mirror 210, a monitor 220, and a control unit 310. The explanations of the camera 100, the electronic rear-view mirror 210, and the monitor 220 will be omitted because they have been described above. The control unit 310 includes, for example, a CPU (Central Processing Unit) configured by at least one or more processors and controls the image processing system 300. The control unit 310 controls image capturing by the camera 100. Additionally, the control unit 310 executes display control processing for displaying an image on the electronic rearview mirror 210 and the monitor 220 based on the image obtained from the camera 100. Note that some functions executed by the control unit 310 may be realized by at east one or more electronic circuits. Each process performed by the control unit 310 is realized according to a predetermined program read from the memory and executed by the CPU.

The control unit 310 causes the electronic rearview mirror 210 to display a partial image by cutting out a region centering around a part where the first field range 110 corresponding to a high resolution region is captured from an image obtained from the camera 100. Additionally, the control unit 310 causes the monitor 220 to display an image obtained from the camera 100 when the vehicle 10 moves backward. Note that when the vehicle 10 moves backward, instead of displaying the entire image, the control unit 310 may cause the monitor 220 to display a partial image obtained by cutting out the region on the lower side of the image including the rear end of the vehicle 10 from the image obtained from the camera 100.

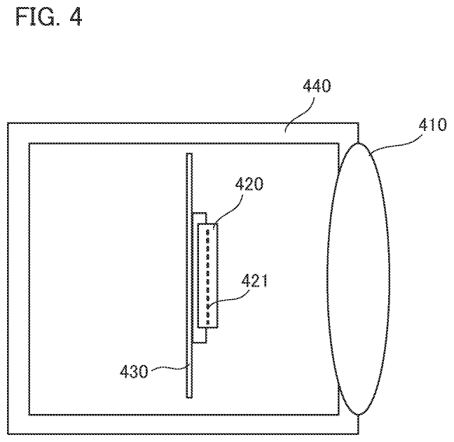

FIG. 4 is a schematic view showing the structure of the camera 100. The camera 100 has the optical system 410, the image sensor 420, a circuit board 430, and a housing 440. The optical system 410 is an image capture optical system having a plurality of lenses. The optical system 410 images an optical image (object image) on the image sensor 420 from external light. The optical system 410 forms a high-resolution region having a high optical imaging magnification including the optical axis 115 and a peripheral region having a low optical imaging magnification compared to the high-resolution region, around the optical axis 115.

The image sensor 420 is a photoelectric conversion element, for example, a CMOS or a CCD, and converts an object image captured from the optical system 410 imaged on the light-receiving surface into an electric signal, and outputs an output signal (electric signal) corresponding to the object image. The external light incident to the optical system 410 is imaged on a light receiving surface 421, which is a photoelectric conversion area on the image sensor 420, and is converted into an electric signal. A plurality of photoelectric conversion elements is arranged in, for example, a matrix, on the light receiving surface 421, which is an image capture surface, and an electric signal corresponding to the incident light is output from the plurality of photoelectric conversion elements.

The circuit board 430 performs signal processing for converting the electrical signals output from the image sensor 420 into image data and outputting it. The image sensor 420 and the circuit board 430 function as an image pickup means that outputs an image based on an optical image that has been input to the light receiving surface. The housing 440 houses the optical system 410, the image sensor 420, and the circuit board 430.

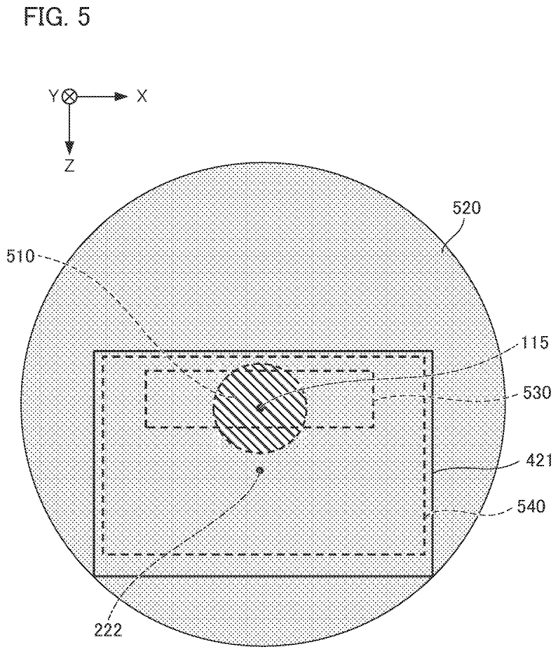

FIG. 5 explains an example of the positional relation between the image sensor 420 and the object image formed by the optical system 410. FIG. 5 is shown as a view of the light receiving surface 421 of the image sensor 420 as viewed from the front direction (Y-axis direction). However, in order to simplify the description, the vertical direction is reversed to the actual case (FIG. 1). This is because the object image, which is formed on the light-receiving surface 421 of the image sensor 420 via the optical system 410, becomes the reverse of the real image. As shown in FIG. 5, the optical system 410 and the image sensor 420 are arranged such that the optical axis 115, which is the optical center of the optical system 410, deviates in the upward direction (Z-axis negative direction) from a center 222 of the light receiving surface 421. In other words, the optical system 410 and the image sensor 420 are arranged such that the center 222 of the light receiving surface 421 deviates in the downward direction (Z-axis positive direction) in FIG. 5, that is, in the upward direction (Z-axis positive direction) in FIG. 1, from the optical axis 115 that is the optical center of the optical system 410. This is because, within a peripheral region 520, the live-action region that is imaged on the light receiving surface 421 and converted into an image is deflected toward the lower side (Z-axis negative direction) in FIG. 1. Thereby, in the image sensor 420, an image is formed in a lower direction (ground direction) from the optical axis 115 larger than the upper direction (sky direction) from the optical axis 115, and an image in the ground direction can be picked up. Note that although a explanation will be given of a configuration in Which the optical axis 115 deviates in the vertical direction (Z-axis direction) from the center of the light receiving surface 421, a configuration in which the optical axis 115 deviates in the horizontal direction (X-axis direction) in addition to the vertical direction (Z-axis direction) is possible.

A high-resolution region 510 and the peripheral region 520 are input to the plane parallel to the light receiving surface 421 via the optical system 410. The high-resolution region 510 is a circular region centering on the optical axis 115, which is shown by diagonal lines in FIG. 5, and the image is formed on the light receiving surface 421. The high-resolution region 510 forms an image with an angle of view corresponding to the first field range 110. The peripheral region 520 is a circular region centering on the high-resolution region 510 and surrounding the high-resolution region 510, and is a region larger than the light receiving surface 421. The peripheral region 520 includes the entire light receiving surface 421. A portion of the peripheral region 520 imaged on the light receiving surface 421 forms an image with an angle of view corresponding to the second field range 120. The optical system 410 and the image sensor 420 need to be arranged such that the region including the ground behind the vehicle 10 where the vehicle 10 is to be moved is displayed on the monitor 220 when the vehicle 10 moves backward. Therefore, in the present embodiment, the optical system 410 and the image sensor 420 are arranged in advance such that the actually captured region that is imaged on the light-receiving surface 421 and converted into an image includes the high-resolution region 510, and deviates downward (in the positive Z-axis direction) within the peripheral region 520. Therefore, in the image output from the camera 100, the region occupied by the image of the first field range 110 corresponding to the high-resolution region 510 is arranged upward side from the center 222 of the image (light receiving surface 421) in FIG. 5. In addition, in the image output from the camera 100, the region occupied by the image of the second field range 120 that corresponding to the peripheral region 520 is larger on the lower side from the optical axis 115 than on the upper side from the optical axis 115, in FIG. 5. Specifically, as shown in FIG. 1, the setting is performed such that the vertical direction in the second field range 120 is set asymmetrically such that the region on the upper side from the optical axis 115 (in the positive Z-axis direction) is narrower and the region on the lower side that is the ground side (in the negative Z-axis direction) is wider.

The control unit 310 displays, on the electronic rear-view mirror 210, a partial image obtained by cutting out a first output range 530, which is mainly a region including the high-resolution region 510 imaged on the light receiving surface 421, that is, a region where the first field range 110 is imaged, from the image output from the camera 100. Such a display of the electronic rear-view mirror 210 is used to confirm and monitor the rear view during normal forward travel. Therefore, for example, it is necessary to display an object such as a vehicle, situated far behind that is moving at a high speed with a large size with high resolution from a distance. From the viewpoint of safety, since the range displayed on the electronic rear-view mirror 210 needs to be 20 m or more in the horizontal direction at the point 60 m behind the vehicle 10, the angle of view in the horizontal direction of the first output range 530 is set to 18 degrees or more.

The control unit 310 displays, on the monitor 220, a partial image obtained by cutting out a second output range 540 including the first output range 530 from the image output from the camera 100. The display of the monitor 220 is used mainly for guiding the moving direction and confirming the environment around the rear when the vehicle 10 is traveling backward. The second output range 540 includes the high-resolution region 510 imaged on the light receiving surface 421, that is, the first field range 110 on the upper side in FIG. 5, and further includes many images in which the peripheral region 520, in other words, the second field range 120, is captured. In order to cause the monitor 220 to display many images in a ground direction in particular, the second output range 540 includes a ground direction (Z-axis negative direction) from the optical axis 115 in FIG. 1 wider than an upward direction (Z-axis positive direction) from the optical axis. Note that the control unit 310 may cause the monitor 220 to display the entire image acquired from the camera 100.

As shown in FIG. 1, the second field range 120 has a larger region below (in the negative Z-axis direction) a plane parallel to the plane 130 that passes through the optical axis 115 and extends behind the vehicle 10 (in the negative Y-axis direction). The second field range 120 is preferably arranged so as to include a tangential line 140 between the front lens ball at the outermost of the optical system 410 of the camera 100 and the rear end portion of the exterior at the rear of the vehicle. This indicates that the rear end portion of the vehicle 10 is always included in the second field range 120. Therefore, a part of the rear end portion of the vehicle 10 and the ground behind the vehicle 10 are displayed on the monitor 220 by displaying an image including the lower part of the second field range 120 on the monitor 220. When the driver moves 11 the vehicle 10 in a backward direction, the driver 11 can easily confirm the details behind the vehicle 10 and the distance perspective from the vehicle 10 by the monitor 220.

Using the image processing system 300 configured as described above makes it possible to obtain, from a single camera, an image for the electronic rear-view mirror 210 for confirming a far distance behind the vehicle 10 and an image for the monitor 220 for confirming a near distance behind the vehicle 10.

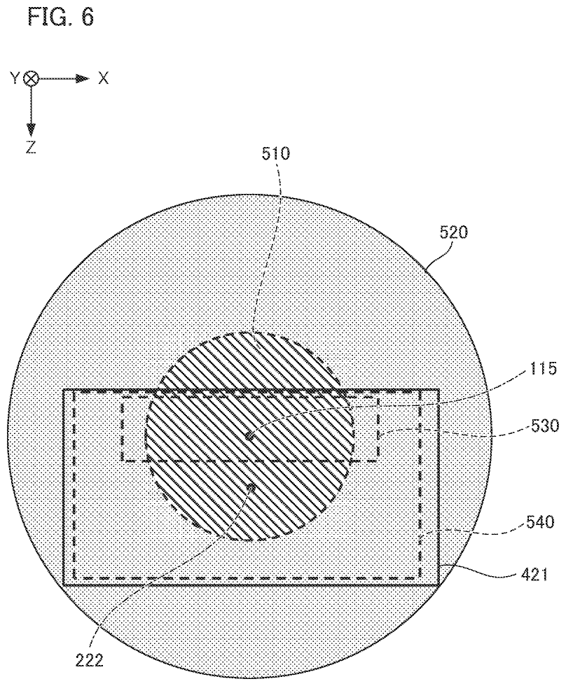

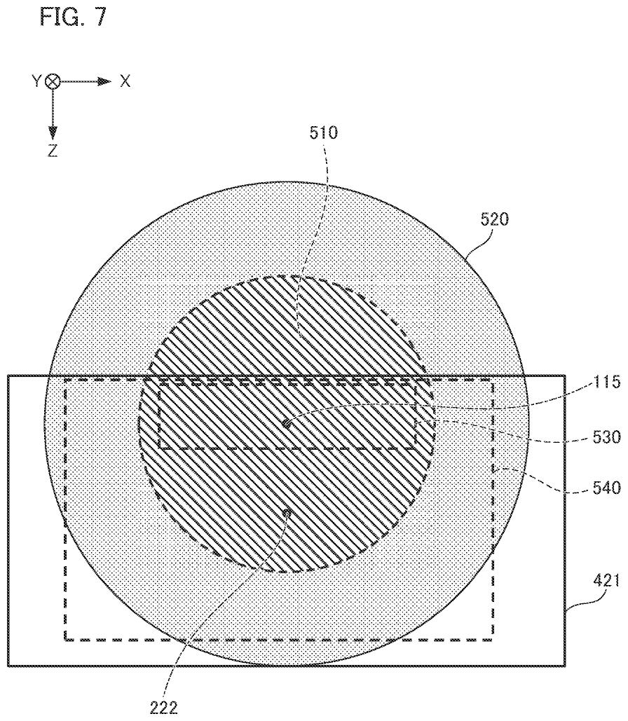

Note that the relation between the high resolution region 510 and the peripheral region 520 on the light receiving surface 421 is not limited to the example in FIG. 5. An example of the relation between the high-resolution region 510 and the peripheral region 520 on the light receiving surface 421, which is different from that in FIG. 5, will be described with reference to FIG. 6 and FIG. 7. Note that, in FIG. 6 and FIG. 7, the configuration in which the optical system 410 and the image sensor 420 are arranged such that the center 222 of the light receiving surface 421 deviates from the optical axis 115 that is the optical center of the optical system 410 in the upward direction (Z-axis positive direction) in FIG. 1 is the same as that in FIG. 5.

FIG. 6 is a drawing for explaining an example of the positional relation between the high resolution region and the peripheral region on the light receiving surface 421. As shown in FIG. 6, a configuration may be adopted in which the high resolution region 510 is larger than the high resolution region 510 shown in FIG. 5, and a part of the high resolution region 510 extends from the light receiving surface 421. The first output range 530 output to the electronic rear-view mirror 210 includes the center of the high-resolution region 510, and includes more high resolution region 510 than peripheral region 520. The second output range 540 that is output to the monitor 220 includes the first output range 530, and includes a portion of the peripheral region 520 located lower than the first output range 530. The second output range 540 includes the peripheral region 520 that is equal in size to or larger than the high resolution region 510.

FIG. 7 explains an example of the positional relation between the high resolution region and the peripheral region on the light receiving surface 421. As shown in FIG. 7, a configuration may be adopted in which the high-resolution region 510 is more large than the high-resolution region 510 shown in FIG. 6, a part of the high-resolution region 510 extends from the light receiving surface 421, and a part of the light receiving surface 421 does not cover the peripheral region 520. The first output range 530 that is output to the electronic rear-view mirror 210 includes the center of the high-resolution region 510, and the entire first output range 530 is the high-resolution region 510. It is arranged such that the length of the long side of the light receiving surface 421 is longer than the diameter of the peripheral region 520, and the bottom border of the light receiving surface 421 overlaps the lowermost side of the peripheral region 520. Therefore, on a part of the light receiving surface 421, a blank region is produced wherein image-formation is not performed. The second output range 540 that is output to the monitor 220 includes the first output range 530 and includes a part of the peripheral region 520 located lower than the first output range 530 and a part of the blank region. The second output range 540 includes the peripheral region 520 that is equal in size to or narrower than the high-resolution region 510. Even in the configurations in FIG. 6 and FIG. 7 as well, a single camera can display a high-resolution video image that is far behind the vehicle 10 on the electronic rear-view minor 210 and can display a video image including the ground surface near behind the vehicle on the monitor 220.

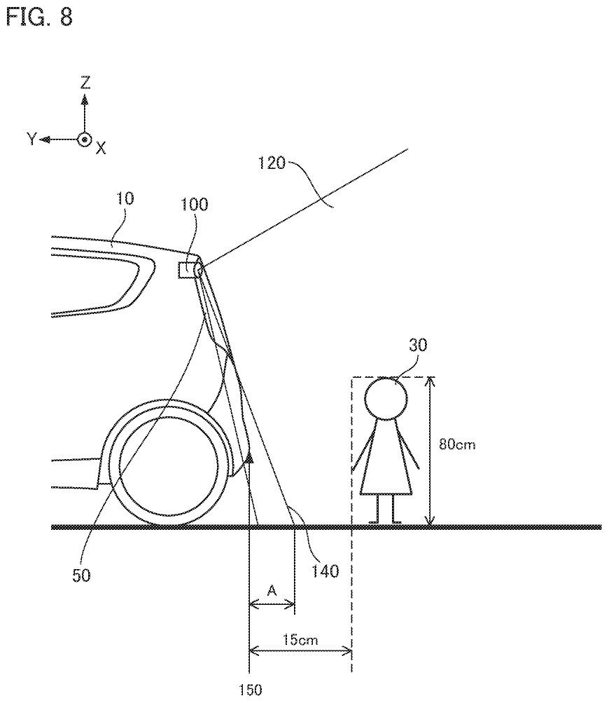

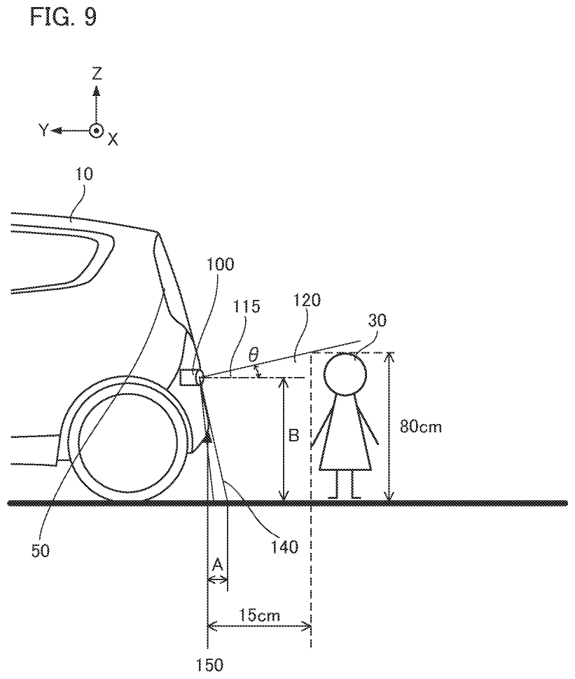

Next, the preferred arrangement of the camera 100 will be explained with reference to FIG. 8 to FIG. 11 by exemplifying various vehicle shapes. First, a case in which the vehicle 10 whose rear end is continuously perpendicular to the rear window portion when viewed from the YZ plane, which is common in the type referred to as a station wagon or minivan as shown in FIG. 1, will be explained with reference to FIGS. 8 and 9. FIG. 8 is a schematic diagram showing the relation between the field range of the camera 100 and an object behind the vehicle 10. In order to ensure that even a small object can be confirmed by the monitor 220, in the example, a case will be explained in which the object that is situated near the rear side of the vehicle 10 is an infant 30 with a height of 80 cm.

The infant 30 is 80 cm in height and is positioned, for example, 15 cm behind the rear end portion 150 of the vehicle 10. The distance A is a distance between the point where the tangential line 140 drawn from the camera 100 toward the rear end of the exterior of the vehicle 10 (for example, the lower end of the rear window portion) is in contact with the ground surface and the rear end portion 150 that is the lower side of the vehicle 10. As shown in FIG. 8, the camera 100 is arranged at the center in the X direction of the rear portion of the vehicle 10 and near the upper end in the Z direction of the rear window portion 50. This arrangement makes it possible to secure a wide field of view of the camera 100 far behind, and also has an effect of reducing a sense of discomfort of the driver 11 when the rear-view mirror mode and the electronic rear-view mirror mode are switched. In addition, the second field of view 120 of the camera 100 is arranged so as to include the rear end portion 150 of the vehicle 10. Thus, it is possible to provide a situation in which the driver 11 of the vehicle 10 can easily feel a distance between an object behind and the vehicle 10. However, if the second field range 120 of the camera 100 includes the rear end portion 150 of the vehicle 10, the region of the second field range 120 of the camera 100 near the ground surface is blocked by the vehicle 10, consequently, the camera 100 cannot capture the region near the ground at the distance A. In particular, it is known that there are many accidents in which an infant is run over during backward travel for parking, and it is important that a field of view near the ground surface nearest to the vehicle is secured by the camera 100. Therefore, the camera 100 needs to be arranged so that the whole body of the infant 30 with a height of 80 cm situated at a position 15 cm behind the rear end portion 150 of the vehicle 10 can be displayed by taking into consideration the second field range 120 and the shape of the rear end of the vehicle 10. That is, the camera 100 is arranged at the position where the distance A is 15 cm or less. In order to secure a wide field of view toward a far distance in the backward direction during the display of the electronic rear-view mirror 210 and in order to display the whole body of the infant 30 for safely during the display of the monitor 220, the camera 100 is arranged at a sufficiently upper side of the vehicle 10 and at a position where the distance A is 15 cm or less. Note that although the present embodiment has explained an example in which the camera 100 capable of displaying the whole body f the infant 30 with a height of 80 cm situated at the position 15 cm behind the rear end portion 150 of the vehicle 10 is located on the monitor 220, the present invention is not limited thereto. In the present embodiment, the camera 100 may be arranged at a position where the whole body of the infant 30 with a height of 80 cm situated at the position 30 cm behind the vehicle 10 on the monitor 220 can be displayed.

FIG. 9 is a schematic view illustrating the case in which the camera 100 is arranged at a lower position in the field where the whole body of the infant 30 is within the second field of view 120. The optical axis 115 is parallel to the moving direction of the vehicle 10. The height B represents the height from the ground surface to the camera 100, and the angle θ represents the vertical field angle from the optical axis 115 of the camera 100 to the upper side of the second field range 120. At this time, the height B that is necessary for including the whole body of the infant 30 in the second field range 120 of the camera 100 can be defined by B=80−15×tan θ. Specifically, when the angle θ is 20°, it is preferable that the camera is arranged at the height of 75 cm or more from the ground surface. However, in the station wagon type vehicle 10 shown in FIG. 8 and FIG. 9, because the distance A, which indicates a distance in which the camera cannot capture images near the ground surface, can be made smaller, compared to a sedan type vehicle to be described below, it is preferable that the camera is arranged near the upper end of the rear window portion 50 in the Z direction as explained above. Additionally, because the camera 100 in the present embodiment has a larger region on the lower side of the second field range 120 than on the upper side thereof, the camera 100 can be arranged at a high position of the vehicle 10 while the field of view near the ground is secured.

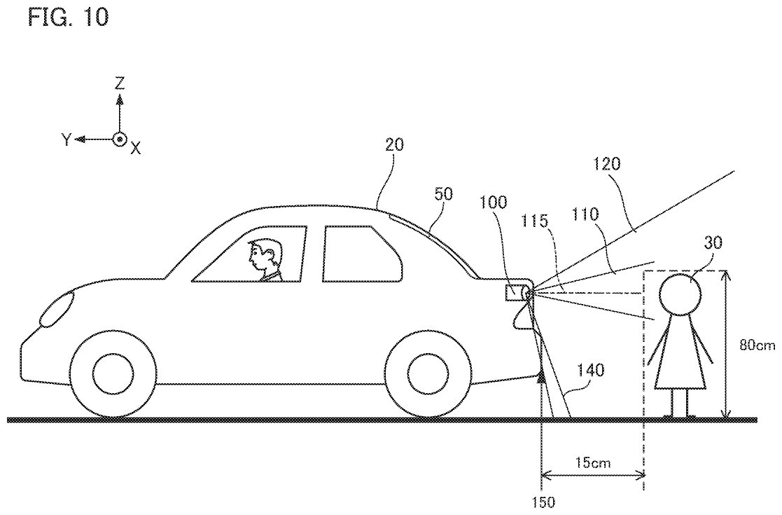

Next, an explanation will be given of the arrangement of the camera 100 on the vehicle 20 having a trunk room provided at the rear end of the vehicle and protruding rearward, which is common in types referred to as sedans and coupes as shown in FIG. 10. FIG. 10 is a drawing that explains the relation between the field of view of the camera 100 on the vehicle having a trunk room protruding rearward and an object behind the vehicle. As in FIG. 8, in an example, an explanation is provided in which the object is the infant 30 with a height of 80 cm.

The camera is arranged at the center in the X direction near the upper end of the rear end portion 150 of the trunk room, instead of locating the camera at the upper end of the rear window portion 50, as shown in FIG. 10. This disposition makes it easy to reduce the region blocked by the vehicle 20 within the second field range 120 and secure a field of view nearest to the rear side of the vehicle 20. Additionally, from the viewpoint of securing a field of view for safety during backward traveling, disposing the camera such that the whole body of the infant 30 with the height of 80 cm situated at the position 15 cm behind the rear end portion 150 of the vehicle 20 can be displayed is the same as the case of the vehicle 10 in FIG. 8. Note that when arranged in this manner, in the camera 100 of the present embodiment, because the face of the infant 30 can be captured in the high-resolution region 510 near the optical axis 115, there is also an advantage in which the driver 11 can easily recognize the infant 30.

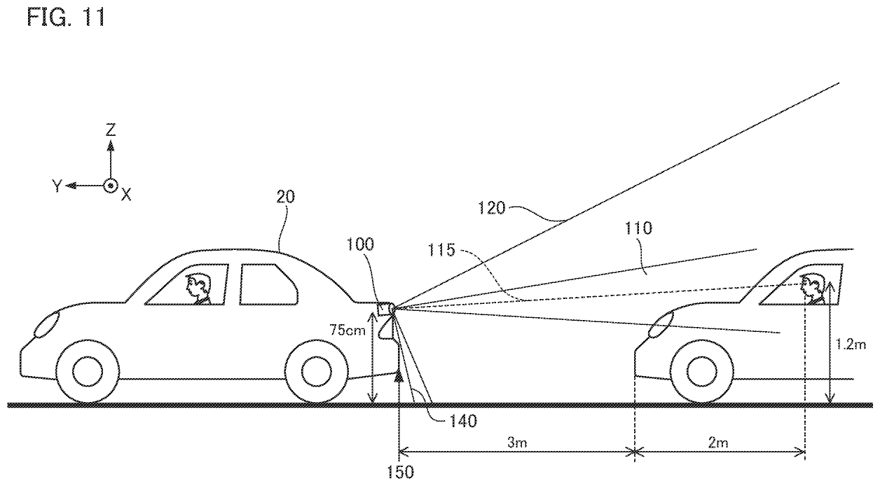

FIG. 11 is a drawing that explains the relation between the field range of the camera 100 arranged on the vehicle 20 having a trunk room protruding backward and a vehicle behind the vehicle 20. In the case in which the optical axis 115 of the camera 100 is located horizontal to the ground surface, if a sufficient field of view far behind to be displayed on the electronic rear-view mirror 210 cannot be secured, the optical axis 115 of the camera 100 may be arranged to be slightly tilted in the positive Z-axis direction instead of horizontal to the ground surface as shown in FIG. 11. When the optical axis 115 of the camera 100 is tilted it is preferable to be configured such that for the driver that the face of a driver of the vehicle at the position of 3 m behind the vehicle 10 is positioned substantially in the center in the vertical direction of the first field range 110 of the electronic rear-view mirror 210. Therefore, the camera 100 is arranged such that the position of the face of the driver of the vehicle situated 3 m behind the vehicle 10 is included in the high-resolution region 510. Specifically, assuming that the eye level of the driver of the vehicle in back is 1.2 m, the eye position is 2 m from the front face of the vehicle, and the height at which the camera 100 is installed is 75 cm, the optical axis of the camera 100 is tilted about 5° in the positive Z-axis direction. Additionally, when the optical axis 115 of the camera 100 is tilted in the positive Z-axis direction, the display of the monitor 220 shows an image viewed from below, thereby there is the possibility that causing the driver of the vehicle will feel a sense of incongruity depending on the degree. Therefore, when the optical axis 115 of the camera 100 is tilted in the positive Z-axis direction, that is, when the optical axis 115 is not parallel to the moving direction of the vehicle 10, image processing for correcting distortion of images to obtain an image viewed horizontally is performed in the control unit 310. The image correction enables further improving the visibility of the image being displayed.

As disclosed above, according to the present embodiment, it is possible to acquire images for the electronic rear-view mirror 210 for confirming a region that is a far distance behind the vehicle 10 and images for the monitor 220 for confirming safety near the rear side of the vehicle 10 by a single camera.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention n described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-167224, filed Oct. 12, 2021, which is hereby incorporated by reference wherein in its entirety.

What is claimed is:

1. An imaging apparatus that images an image behind a vehicle to display an image behind the vehicle on an electronic rear-view mirror and a monitor installed on the vehicle comprising:
an optical system configured to have a first region that has a high image-forming magnification and a second region that is formed around the first region and has a lower image-forming magnification than the first region and to form an optical image on an imaging sensor; and
an imaging sensor configured to output an image based on an optical image formed on the imaging sensor,
wherein the imaging apparatus is arranged on the vehicle such that a ground surface that is behind and near the vehicle and the position 80 cm high from the ground surface is included within a second field range in which an image is formed on the imaging sensor via the second region of the optical system.

2. The imaging apparatus according to claim 1, wherein the center of the image pickup surface of the imaging sensor is arranged in the upward direction with respect to the optical axis of the optical system.

3. The imaging apparatus according to claim 1, wherein the ground surface that is behind and near the vehicle is the ground surface 15 cm or 30 cm behind the vehicle.

4. The imaging apparatus according to claim 1, wherein the imaging apparatus is arranged on the vehicle such that the rear end of the vehicle is included within the second field of view.

5. The imaging apparatus according to claim 1, wherein the imaging apparatus is arranged on the vehicle such that the position of the face of a driver of a vehicle situated 3 m behind the vehicle is included within a first field range in which an image is firmed on the imaging sensor via the first region of the optical system.

6. The imaging apparatus according to claim 1, wherein the optical axis of the optical system is parallel to the moving direction of the vehicle.

7. The imaging apparatus according to claim 1, wherein the imaging apparatus is arranged at the height of 75 cm or more from the ground surface.

8. The imaging apparatus according to claim 1, wherein the first region has high resolution, and the second region has lower resolution than the resolution of the first region.

9. An image processing system comprising:
an imaging apparatus that picks up an image behind a vehicle in order to display an image behind the vehicle on an electronic rear-view mirror and a monitor installed on the vehicle; and
at least one processor configured to perform control for causing the electronic rear-view mirror and the monitor to display an image output from the imaging apparatus,
wherein the imaging apparatus comprising:
an optical system configured to have a first region that has a high image-forming magnification and a second region that is formed around the first region and has a lower image-forming magnification than the first region and to form an optical image on an imaging sensor; and
an imaging sensor configured to output an image based on an optical image formed on the imaging sensor,
wherein the imaging apparatus is arranged on the vehicle such that a ground surface that is behind and near the vehicle and the position 80 cm high from the ground surface is included within a second field range in which an image is formed on the imaging sensor via the second region of the optical system.

10. The image processing system according to claim 9, wherein the processor causes the electronic rear-view mirror o display a first partial image of the image picked up by the imaging sensor, which is mainly a first field range in which an image is formed on the imaging sensor via the first region, and causes a monitor to display a second partial image of the image picked up by the imaging sensor, which includes a ground surface direction from the optical axis of the optical system that is wider than an upper direction from the optical axis.

11. The image processing system according to claim 9, wherein the angle of view of the first partial image in the horizontal direction is 18 degrees or more.

12. The image processing system according to claim 9, wherein the position of the face of a driver of a vehicle behind the vehicle is displayed at the center of the first partial image.

13. The image processing system according to claim 9, wherein the second partial image includes the first partial image on the upper side.

14. The image processing system according to claim 9, wherein the second partial image includes a part of the rear end of the vehicle.

15. The image processing system according to claim 9, wherein the ground surface 15 cm behind the vehicle and a position 80 cm high from the ground are included within the second partial image.

16. The image processing system according to claim 9, wherein if the optical axis of the optical system is not parallel to the moving direction of the vehicle, the processor performs image processing for correcting distortion of images.

17. A vehicle comprising:
an electronic rear-view mirror that displays a first partial image;
a monitor that displays a second partial image;
an imaging apparatus that picks up an image behind a vehicle in order to display an image behind the vehicle on the electronic rear-view mirror and the monitor; and
at least one processor configured to perform control for causing the electronic rear-view mirror and the monitor to display an image output from the imaging apparatus, wherein the imaging apparatus comprises:
an optical system configured to have a first region that has a high image-forming magnification and a second region that is formed around the first region and has a lower image-forming magnification than the first region and to form an optical image on an imaging sensor; and
an imaging sensor configured to output an image based on an optical image formed on the imaging sensor,
wherein the imaging apparatus is arranged on the vehicle such that a ground surface that is behind and near the vehicle and the position 80 cm high from the ground surface is included within a second field range in which an image is formed on the imaging sensor via the second region of the optical system.

18. A control method of an image processing system that includes an optical system that has a first region having a high image-forming magnification and a second region formed around the first region and having a lower image-forming magnification than the first region and forms an optical image on an imaging sensor, and the imaging sensor, and that causes an electronic rear-view minor and a monitor to display an image behind a vehicle output from an imaging apparatus arranged on the vehicle such that a ground surface that is behind and near the vehicle and the position 80 cm high from the ground surface are included within a second partial image that is captured by the imaging sensor via the second region of the optical system, the control method comprising:
outputting an image based on an optical image formed on the imaging sensor;
causing the electronic rear-view mirror to display, among the images, a first partial image of the image that is mainly a first field range in which an image is formed on the imaging sensor via the first region; and
causing a monitor to display, among the images, a second partial image including a ground direction from the optical axis of the optical system wider than the upward direction of the optical axis.

19. A non-transitory recording medium storing a control program of an image processing system that includes an optical system that has a first region having a high image-forming magnification and a second region formed around the first region and having a lower image-forming magnification than the first region and forms an optical image on an imaging sensor, and the imaging sensor, and that causes an electronic rear-view mirror and a monitor to display an image behind a vehicle output from an imaging apparatus arranged on the vehicle such that a ground surface that is behind and near the vehicle and the position 80 cm high from the ground surface are included within a second partial image that is captured by the imaging sensor via the second region of the optical system causing a computer to perform each step of a control method of the image processing system, the method comprising:
outputting an image based on an optical image formed on the imaging sensor;
causing the electronic rear-view mirror to display, among the images, a first partial image of the image that is mainly a first field range in which an image is formed on the imaging sensor via the first region; and
causing a monitor to display a second partial image that includes, among the images, a ground direction from the optical axis of the optical that is wider than the upward direction of the optical axis.
